(19) United States
(12) Patent Application Publication
(10) Pub. No.: US 2010/0272629 A1
(43) Pub. Date: Oct. 28, 2010

(54) Method and system for providing a substance with receptive and/or transmissive properties for a signal

(75) Inventors: Jacques Benveniste, Paris (FR); Jerome Benveniste, Monteporzio Catone (IT); Vincent Benveniste, Paris (FR); Laurent Benveniste, Les Mureaux (FR); Claire Benveniste, Paris (FR); Alice Benveniste, Paris (FR)

Correspondence Address: FULBRIGHT & JAWORSKI, LLP, 666 FIFTH AVE, NEW YORK, NY, 10103-3198, US

(73) Assignee: DIGIBIO SA, PARIS (FR)

(21) Appl. No.: 11/628,388

(22) PCT Filed: Jun. 1, 2005
(86) PCT No.: PCT/FR2005/050405

§ 371 Date: May 10, 2010

(30) Foreign Application Priority Data
Jun. 1, 2004 (FR) 0451080

(51) Int. Cl. B01J 19/12; B06B 1/00; C01B 5/00

(52) U.S. Cl. 423/580.1; 204/157.4; 204/157.42; 422/127; 422/186

(57) ABSTRACT

The invention relates to a method and a system for giving a substance (101) receptive and/or transmissive properties that allow the substance (101) to be treated by and/or to transmit a signal acquired by intercepting an electromagnetic field originating from a source substance. The substance (101) is subjected, by means of a transmitter (102), to an electromagnetic field and/or a sound (104) emitted at one or more frequencies included in a predetermined frequency spectrum for a predetermined period. The invention makes it possible to give the initially non-receptive and non-transmissive substance (101)y receptive and/or transmissive properties.

The present invention relates to a method and a system for ensuring that, after an application of a signal generated from an electromagnetic field produced by a source substance, a substance, particularly water, has an active property of the source substance.

It is known, particularly from French patent FR 2783606, that it is possible to produce a substance having a property of a source substance by applying to the substance, which is initially inactive, a signal generated from, and as a function of, the electromagnetic field produced by the source substance.

This active property can be a biological and/or chemical activity or a biological and/or chemical behavior.

It has been observed that the application of such a signal to the substance does not guarantee that subsequent to this application, the substance will acquire the active property of the source substance. Wide variations are observed in a substance's ability to acquire an active property of a source substance through the application of a signal.

In particular, sometimes water that is subjected to a signal generated from, and as a function of, the electromagnetic field produced by an active source substance does not have a specific activity. The signal seems not to have acted on the water so as to render it active. Thus, the water's capacity to register, i.e. to retain a trace of, the signal to which it has been subjected varies from experiment to experiment between 0% to 100%, even when a specific robot performs the manipulations. Among other things, this poses an obvious problem in terms of reproducibility.

The invention solves this reproducibility problem. It consists of treating the substance prior to the application of the signal. To this end, the invention relates to a method for giving a substance, particularly water, receptive and/or transmissive properties that allow the substance to be treated by and/or to transmit a signal, particularly a signal acquired by intercepting an electromagnetic field originating from a source substance, said method comprising the step of subjecting the substance, by means of a transmitter, to an electromagnetic field and/or a sound emitted at one or more frequencies included in a predetermined frequency spectrum for a predetermined period.

In essence, according to the invention, the initially non-receptive and non-transmissive substance is rendered capable of receiving and/or transmitting a signal.

According to other embodiments, the method also comprises a step for agitating the substance, said agitation step being successive to and/or simultaneous with the step of subjecting the substance to an electromagnetic field and/or an emitted sound.

The agitation makes it possible, in particular, to shorten the predetermined period during which the substance is subjected to an electromagnetic field and/or an emitted sound. This agitation consists, for example, of creating a vortex in the solution.

The invention also relates to a system for implementing the method as presented above, a substance that is rendered receptive and/or transmissive according to a method of the invention, and the use of such a substance to produce a substance having an active property of a source substance.

Other features and advantages of the invention will emerge from the description below, given by way of an illustrative and nonlimiting example with reference to the attached drawings, in which:

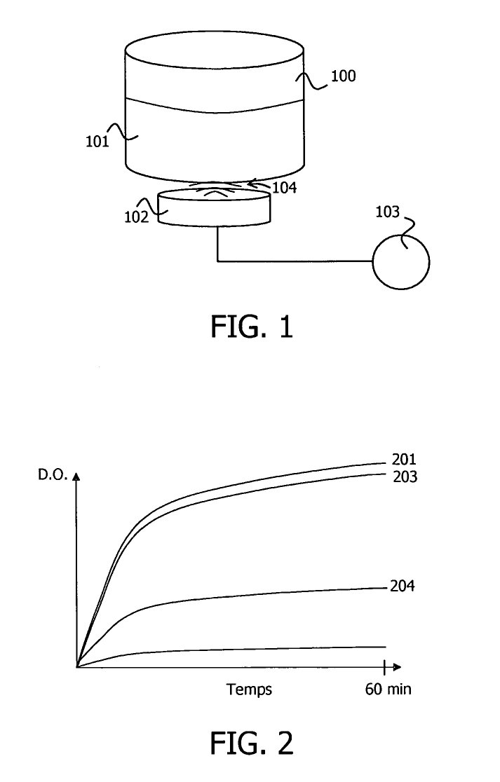

FIG. 1 represents a system according to the invention.

FIG. 2 is a diagram illustrating the presence or non-presence of an active property in substances that are or are not obtained according to the invention.

According to FIG. 1, a system according to the invention includes a transmitter 102 for subjecting the substance 101 to an electromagnetic field and/or a sound 104 emitted at one or more frequencies included in a predetermined frequency spectrum for a predetermined period.

The transmitter is, for example, a loudspeaker for subjecting the substance to a frequency applied in sound form.

It is also possible for the transmitter to be an electromagnetic wave transmitter, for example an electromagnetic coil which, for example, subjects the substance to a frequency range of 50 Hz, 500 Hz, etc., i.e. white noise.

The frequency or frequencies are chosen from a predetermined frequency spectrum by an electromagnetic field generator 103 and/or a sound generator 104.

It is possible to use one or more given frequencies for the electromagnetic field and/or the sound 104.

Subjecting the substance, water in this case, to random frequencies covering at least the audible frequency spectrum (20 Hz-20,000 Hz) made it possible to obtain a so-called formatted water, i.e. water having good receptivity and/or good characteristics for transmitting a signal originating from an active source substance.

The random frequencies can be obtained, in particular, by transmitting a piece of music.

Examples of predetermined periods are given below. The generator 103 makes it possible to control the predetermined period. For example, water subjected to music 104 for one night has good receptivity and/or good transmissive characteristics.

According to another embodiment of the invention, the system also includes means for agitating the substance, for example in a swirling fashion.

Creating agitation in the substance makes it possible, in particular, to shorten the predetermined period to which the water must be subjected in order to be formatted. For example, a proper formatting of the water resulting in good receptivity and/or good transmissive characteristics is observed when the water is subjected to music 104 for two hours and successively agitated in a swirling fashion, for example for 20 seconds. It is also possible to agitate the water while simultaneously transmitting the piece of music.

A vessel 100 contains the substance 101. This vessel is for example a cylinder made of transparent plastic. Any other shape (tube, etc.) suitable for receiving the substance, and any other material (glass, metal, etc.) that is permeable to sound and/or electromagnetic waves, may be used. Advantageously, the vessel is placed above the transmitter 102, but any other position that allows the substance to receive the electromagnetic waves and/or sounds 104 is conceivable.

In another embodiment, the transmitter may be placed in the substance, for example, immersed in the water.

FIG. 2 illustrates the action of a method according to the invention on the water's ability to be treated by a signal generated from an electromagnetic field produced by a source substance having an active property.

Hirudin is an anticoagulant that acts by directly inhibiting thrombin. At the active site, the effect of the hirudin is immediate. In the illustration provided, the source substance is hirudin and the signal generated from the electromagnetic field of the source substances is called the “hirudin signal.”

A so-called treatment method that makes it possible to obtain a treated substance, i.e. a substance having the properties of an anticoagulant like hirudin, is described in French patent FR 2783606.

According to this method, the electromagnetic field originating from the hirudin—the source substance—is transformed into an electrical signal by means of a transducer-receiver that intercepts the electromagnetic field. The electrical signal is then applied to a substance by means of a transducer-transmitter.

The substance to which the electrical signal is applied may or may not have been subjected to the method according to the invention.

The experiment consists of comparing substances that have been subjected to a method according to the invention and others that have not been subjected to it, prior to the application of the treatment method.

A solution of water—a substance capable of being subjected to a method according to the invention—that includes thrombin is used as the biological system for revealing an anticoagulant effect of the hirudin or the hirudin signal. The water-thrombin solution is mixed with a fibrinogen solution which, under the effect of the thrombin, results in the formation of a fibrin clot, the final stage of the coagulation.

In order to measure the coagulation, the variation of the optical density of the solution resulting from the mixture is measured as a function of time. Thus, FIG. 2 presents optical density curves (on the ordinate).

The curve 201 represents the evolution of the optical density observed after the addition of a water solution including thrombin in the absence of molecular hirudin into a solution including fibrinogen. The water solution that includes the thrombin is produced with water that has not been subjected to any prior preparation (and thus is not formatted, to use the vocabulary defined above). It may be seen that the optical density increases rapidly; there is coagulation.

FIG. 2 represents the curve 202, which corresponds to the mixture of a water solution including thrombin into which molecular hirudin has been added with a solution including fibrinogen. Only a slight increase in the optical density as a function of time is observed; it is clear that there is no coagulation.

Next, for purposes of comparison, several solutions including thrombin are prepared with water that has not been subjected to a formatting method according to the invention and has been subjected to a treatment method using the hirudin signal as described above. It is observed that the optical density curves obtained after mixture with a solution including fibrinogen are not very reproducible. Thus, it is possible to observe curves like the curve 201, the curve 202, or intermediate curves. For example, the curve 203 represents a non-formatted water solution which does not include molecular hirudin but to which a hirudin signal has been applied. The anti-coagulant effect of the hirudin signal is not observed.

Also, for purposes of comparison, several solutions including thrombin are prepared with water that has been subjected to a formatting method according to the invention and has been subjected to a treatment method by means of a hirudin signal as described above.

The curve 204 represents the results obtained with such water solutions, which include thrombin without molecular hirudin but to which a hirudin signal has been applied.

Such a curve is obtained reproducibly.

Lastly, a curve similar to the curve 201 is obtained with water solutions including thrombin prepared with water that has been subjected to a formatting method according to the invention and has not been subjected to a treatment method by means of the hirudin signal.

Repeated measurements on water samples that have been subjected to a formatting method according to the invention and on water samples that have not been subjected to formatting prior to the application of a hirudin signal show an average anticoagulant activity that is much higher in the samples formatted according to the method of the invention. The table below shows the results of measurements of anticoagulant activity after the application of a hirudin signal to formatted water samples and to non-formatted water samples. The results indicated correspond to the inhibition percentage of the thrombin after thirty minutes. For the sake of comparison, the results of measurements of the anticoagulant activity of a hirudin solution titrated to one μM/L are presented. Thus, a high average value for the hirudin (70.6%), along with a large differential between the average observed in the water samples formatted according to the invention (21.4%) and that observed in the non-formatted water samples (9.6%), is observed.

| Non-formatted water | Formatted water | Hirudin |
|---|---|---|
| 0 | 38 | 65 |
| 15 | 2 | 70 |
| 0 | 25 | 68 |
| 19 | 6 | 72 |
| 24 | 1 | 75 |
| 7 | 39 | 75 |
| 1 | 6 | 69 |
| 32 | 31 | 71 |
| 0 | 8 | Avg. = 70.6% |
| 14 | 10 | |
| 13 | 36 | |
| 0 | 12 | |
| 0 | 61 | |
| 0 | 4 | |
| 21 | 44 | |
| 0 | 0 | |
| 20 | 6 | |
| 10 | 12 | |
| 8 | 40 | |
| 0 | 8 | |
| 16 | 35 | |
| 0 | 2 | |
| 18 | 35 | |
| 26 | 8 | |
| 0 | 6 | |
| 17 | 65 | |
| 0 | 30 | |
| 12 | 26 | |
| 10 | 10 | |
| 6 | 26 | |
| 0 | 31 | |
| 25 | 24 | |
| 0 | 12 | |
| 17 | 8 | |
| 15 | 28 | |
| 0 | 26 | |
| 18 | 12 | |
| 0 | 8 | |
| 13 | 2 | |
| 22 | 81 | |
| 18 | 16 | |
| 0 | 35 | |
| 12 | 20 | |
| 0 | 6 | |
| 8 | Avg. = 21.4% | |
| 0 | | |
| 22 | | |
| 14 | | |
| 0 | | |
| 6 | | |
| 0 | | |
| 14 | | |
| 20 | | |
| 0 | | |
| 25 | | |
| 1 | | |
| Avg. = 9.6% | | |

It is therefore observed that subjecting a substance to a method according to the invention makes it possible to render reproducible the application of a signal generated from the electromagnetic field produced by a source substance containing hirudin.

1. Method for giving a substance (101), particularly water, receptive and/or transmissive properties that allow the substance (101) to be treated by a signal and/or to transmit a signal, particularly a signal acquired by intercepting an electromagnetic field originating from a source substance, comprising the step of subjecting the substance (101), by means of a transmitter (102), to an electromagnetic field and/or a sound (104) emitted at one or more frequencies included in a predetermined frequency spectrum for a predetermined period so that the initially non-receptive and/or non-transmissive substance (101) has receptive and/or transmissive properties.

2. Method according to claim 1, also comprising a step for agitating the substance (101), said agitation step being successive to the step of subjecting the substance (101) to an electromagnetic field and/or an emitted sound (104).

3. Method according to claim 1, also comprising a step for agitating the substance (101), said agitation step being simultaneous with the step of subjecting the substance (101) to an electromagnetic field and/or an emitted sound (104).

4. System for giving a substance (101), particularly water, receptive and/or transmissive properties that allow the substance (101) to be treated by a signal and/or to transmit a signal, particularly a signal acquired by intercepting an electromagnetic field originating from a source substance, comprising a transmitter (102) for subjecting the substance (101) to an electromagnetic field and/or a sound (104) emitted at one or more frequencies included in a predetermined frequency spectrum for a predetermined period so that the initially non-receptive and/or non-transmissive substance has receptive and/or transmissive properties.

5. System according to claim 4, also comprising means for agitating the substance (101), successive to subjecting the substance (101) to an electromagnetic field and/or an emitted sound (104).

6. System according to claim 4, also comprising means for agitating the substance while simultaneously subjecting the substance (101) to an electromagnetic field and/or to an emitted sound (104).

7. Substance (101), particularly water, having receptive and/or transmissive properties that allow the substance (101) to be treated by a signal and/or to transmit a signal, particularly a signal acquired by intercepting an electromagnetic field originating from a source substance, and having been subjected to an electromagnetic field and/or a sound (104) emitted at one or more frequencies included in a predetermined frequency spectrum for a predetermined period.

8. Use of the substance (101) according to claim 5 to produce a substance having the properties of a source substance whose electromagnetic field has made it possible to generate said signal, by applying the signal to the substance (101).
